(19) United States
(12) Patent Application Publication
(10) Pub. No.: US 2013/0094488 A1
(43) Pub. Date: Apr. 18, 2013

(54) METHOD FOR CHANNEL SOUNDING IN WIRELESS LOCAL AREA NETWORK AND APPARATUS FOR THE SAME

(71) Applicant: ELECTRONICS AND TELECOMMUNICATIONS RESEARCH INSTITUTE, Daejeon (KR)

(72) Inventors: Jee Yon CHOI, Daejeon (KR); Sok-kyu LEE, Daejeon (KR)

(73) Assignee: ELECTRONICS AND TELECOMMUNICATIONS RESEARCH INSTITUTE, Daejeon (KR)

(21) Appl. No.: 13/651,311

(22) Filed: Oct. 12, 2012

(30) Foreign Application Priority Data
Oct. 12, 2011 (KR) 10-2011-0104272
Sep. 27, 2012 (KR) 10-2012-0107661

(51) Int. Cl. H04W 84/12

(52) U.S. Cl. 370/338

(57) ABSTRACT

A channel sounding method in a wireless local area network (WLAN) system and an apparatus supporting the same are provided. A method of performing a sounding operation by an access point (AP) in a wireless local area network (WLAN) includes: generating a beamforming report (BR) poll frame including a sounding sequence; transmitting the BR poll frame to a station (STA); and selectively performing transmission beamforming on the station according to whether or not the BR frame is received from the station before a predetermined timeout. Transmission of an erroneous BR frame in case that a beam receiver fails to receive an null data packet announcement (NDPA) and an null data packet (NDP) is eliminated and a degradation of transmission efficiency is prevented.

### CROSS-REFERENCE TO RELATED APPLICATIONS

This application claims the benefit of priority of KR application 10-2011-0104272 filed on Oct. 12, 2011 and KR application 10-2012-0107661 filed on Sep. 27, 2012, all of which are incorporated by reference in their entirety herein.

### BACKGROUND OF THE INVENTION

1. Field of the Invention

The present invention relates to a wireless local area network (WLAN) system and, more particularly, to a method for sounding a channel between stations (STAs) and an apparatus supporting the same in a WLAN system.

2. Related Art

A next-generation WLAN system requires high throughput relative to an existing WLAN system. It is called VHT (Very High Throughput), and to this end, a next-generation WLAN system supports 80 MHz, continuous 160 MHz, non-continuous 160 MHz bandwidth transmission and/or higher bandwidth transmission. Also, for higher throughput, a MU-MIMO (Multi User-Multiple Input Multiple Output) transmission method is provided. In a next-generation WLAN system, an AP (Access Point) may simultaneously transmit a data frame to one or more MIMO-paired stations (STAs).

In the WLAN system, an AP and/or STA may obtain information regarding a channel to be used in transmitting a frame to a reception target AP and/or STA. This may be performed through a channel sounding procedure. Namely, a transmitter may request information regarding a channel to be used for frame transmission and reception from the receiver, and the receiver estimates a channel and feeds corresponding channel information to the transmitter, and this process may be performed before a data transmission is transmitted and received. Meanwhile, a next-generation WLAN adopts a broader channel bandwidth and a MU-MIMO technique, an amount of channel information received from a transmission target AP and/or STA may be increased. In order to transmit more feedback information, a transmission target AP and/or STA should access a channel for a longer period of time.

The AP and/or STA may not normally receive required control information during a process for channel sounding. Thus, feedback with respect to the control information or data cannot be accurately transmitted or received. In this case, an STA and/or STAs intending to estimate a channel cannot normally perform channel estimation. Thus, an STA and/or STAs that have already estimated a channel consume(s) power according to an unnecessary operation and an inaccurate feedback channel is unnecessarily occupied. Thus, an introduction of a channel sounding method that may solve the foregoing problem is required.

### SUMMARY OF THE INVENTION

The present invention provides a channel sounding method and an apparatus supporting the same in a wireless local area network (WLAN) system.

The present invention also provides a protocol of a WLAN.

The present invention also provides a sounding protocol required for using transmission beamforming, and a structure of a frame for the sounding protocol.

In an aspect, a method of performing a sounding operation by an access point (AP) in a wireless local area network (WLAN) is provided. The method may include: generating a beamforming report (BR) poll frame including a sounding sequence; transmitting the BR poll frame to a station (STA); and selectively performing transmission beamforming on the station according to whether or not the BR frame is received from the station before a predetermined timeout.

In another aspect, an access point (AP) performing a sounding operation in a wireless local area network (WLAN) is provided. The AP may include: a frame generation unit configured to generate a beamforming report (BR) poll frame including a sounding sequence; a transmission unit configured to transmit the BR poll frame to a station (STA); and a beamforming controller configured to selectively perform transmission beamforming on the station according to whether or not the BR frame is received from the station before a predetermined timeout.

In another aspect, a method for performing a sounding operation by a station in a wireless local area network (WLAN) is provided. The method may include: receiving a beamforming report (BR) poll frame from an access point (AP); comparing a first sounding sequence included in a null data packet (NDP) or an NDP announcement (NDPA) which has been most recently received from the AP with a second sounding sequence included in the BR poll frame; and selectively transmitting the BR frame including channel information to the AP based on whether or not the first sounding sequence and the second sounding sequence are identical.

In another aspect, a station performing a sounding operation in a wireless local area network (WLAN) is provided. The station (STA) may include: a reception unit configured to receive a beamforming report (BR) poll frame from an access point (AP); a channel estimation unit configured to compare a first sounding sequence included in a null data packet (NDP) or an NDP announcement (NDPA) which has been most recently received from the AP with a second sounding sequence included in the BR poll frame; and a frame generation unit configured to selectively generate a BR frame including channel information based on whether or not the first sounding sequence and the second sounding sequence are identical.

According to embodiments of the present invention, a novel structure of a BR poll frame is provided in a sounding protocol for transmission beamforming, thereby eliminating transmission of an erroneous BR frame in case that a beam receiver fails to receive an null data packet announcement (NDPA) and an null data packet (NDP), and preventing a degradation of transmission efficiency.

### BRIEF DESCRIPTION OF THE DRAWINGS

FIG. 1 is a view illustrating a configuration of a wireless local area network (WLAN) system to which an embodiment of the present invention is applied.

FIG. 2 is a view illustrating a channel sounding method using an NDP in the next-generation WLAN system to which an embodiment of the present invention is applied.

FIG. 3 is a view illustrating an NDPA frame to which an embodiment of the present invention is applied.

FIG. 4 is a view illustrating MIMO control information to which an embodiment of the present invention is applied.

FIG. 5 is a view illustrating a structure of a BR poll frame to which an embodiment of the present invention is applied.

FIG. 6 is a view illustrating an example of a scenario that may be generated during a sounding operation.

FIG. 7 is a view illustrating a structure of the BR poll frame to which an embodiment of the present invention is applied.

FIG. 8 is a view illustrating a sounding operation based on BR poll frame according to an embodiment of the present invention.

FIG. 9 is a flow chart illustrating a method for performing a sounding operation by an AP according to an embodiment of the present invention.

FIG. 10 is a flow chart illustrating a method for performing a sounding operation by an STA according to an embodiment of the present invention.

FIG. 11 is a block diagram illustrating an AP performing a sounding operation according to an embodiment of the present invention.

FIG. 12 is a block diagram illustrating an STA performing a sounding operation according to an embodiment of the present invention.

### DESCRIPTION OF EXEMPLARY EMBODIMENTS

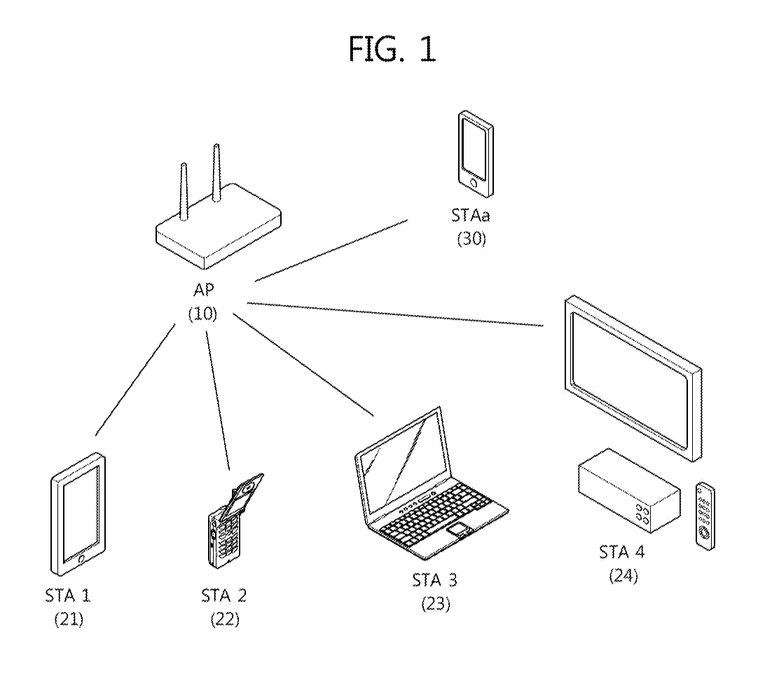

FIG. 1 is a view illustrating a configuration of a wireless local area network (WLAN) system to which an embodiment of the present invention is applied.

A WLAN system includes one or more of basic service sets (BSSs). A BSS refers to a set of stations (STAs) that can communicate with each other in synchronization, rather than a concept indicating a particular area.

An infrastructure BSS includes one or more non-AP stations (non-AP STAs), an access point (AP) providing a distribution service (DS), and a distribution system connecting the plurality of APs. In the infrastructure BSS, the AP manages the non-AP STAs of the BSS.

Meanwhile, the IBSS is a BSS operating in an ad-hoc mode. The IBSS does not include an AP, so it cannot be a centralized management entity performing a management function at the center. Namely, in the IBSS, non-AP STAs are managed in a distributed manner. IN the IBSS, every STA may be configured as a mobile station, and the IBSS establishes a self-contained network, not allowing an access to a distribution system (DS).

A station (STA) is a certain functional medium including a medium access control (MAC) following the stipulation of IEEE 802.11 standard and a physical layer interface with respect to a wireless medium. A station includes both AP and non-AP stations in a broad sense.

A non-AP STA is an STA which is not an AP. The non-AP STA may be referred to by other names such as mobile terminal, wireless device, wireless transmit/receive unit (WTRU), user equipment (UE), mobile station (MS), mobile subscriber unit, simply, user, or the like. Hereinafter, a non-AP STA will be designated by STA.

The AP is a functional entity for providing an access to the DS by way of a wireless medium for an STA (Associated Station) associated thereto. In the infrastructure BSS including the AP, in principle, communications between non-STAs are made by way of the AP, but when a direct link has been established, the STAs can directly communicate with each other. The AP may be also called by other names such as centralized controller, base station (BS), node-B, base transceiver system (BTS), site controller, and the like.

A plurality of infrastructure BSSs including the BSS illustrated in FIG. 1 may be connected via the DS. The plurality of BSSs connected via the DS is called an extended service set (ESS). The AP 10 and/or STAs 21, 22, 23, 24, and 25 included in the ESS may communicate with each other, and a non-AP STA may move from one BSS to another BSS within the same ESS while seamlessly performing communication.

In the WLAN system according to IEEE 802.11, a basic access mechanism of MAC (Medium Access Mechanism) is a CSMA/CA (Carrier Sense Multiple Access with Collision Avoidance). The CSMA/CA mechanism is also called a DCF (Distributed Coordination Function) of IEEE 802.11 MAC, basically employing a ‘listen before talk’ access mechanism. In this type of access mechanism, an AP and/or station (STA) senses to a radio channel or a medium before starting a transmission. As a result of sensing, when it is determined that the medium is in an idle status, the AP and/or station STA starts a packet transmission through the corresponding medium. Meanwhile, when it is detected that the medium is in an occupied state, the corresponding AP and/or STA does not start its transmission but sets a delay period for media access and waits.

The CSMA/CA mechanism includes virtual carrier sensing as well as physical carrier sensing in which the station (STA) directly senses a medium. The virtual carrier sensing is to complement a problem that may arise in media access, such as a hidden node problem, or the like. For the virtual carrier sensing, the MAC of the WLAN system uses an NAV (Network Allocation Vector). The NAV is a value for the AP and/or STA, which currently uses the medium or has authority to use the medium, to indicate a time remaining for the medium to be available, to a different AP and/or STA. Thus, the value set as the NAV corresponds to a period during which the medium is due to be used by the AP and/or STA which transmits a corresponding packet.

Along with a DCF, an IEEE 802.11 MAC provides an HCF (Hybrid Coordination Function) based on a PCF (Point Coordination Function) which periodically polls to allow every reception AP and/or STA to receive a data packet in a synchronous access scheme based on polling along with the DCF. The HCF has an HCCA (HCF Controlled Channel Access) using an EDCA (Enhanced Distributed Channel Access) based on contention as an access scheme in which a provider provides data packets to a plurality of users and a channel access scheme based on contention-free using a polling mechanism. The HCF includes a medium access mechanism for enhancing QoS (Quality of Service) of the WLAN, and may transmit QoS data in both of a contention period (CP) and a contention-free period (CFP).

The AP and/or STA may perform a procedure for exchanging an RTS (Request to Send) frame and a CTS (Clear to Send) frame in order to inform about an access to a medium. When substantial data frame transmission and reception acknowledgement is supported, the RTS frame and the CTS frame include information indicating a temporal section reserved for a wireless medium required for transmitting and receiving an acknowledgement frame (ACK) frame to access. An AP that wants to transmit a frame and/or a different STA, which has received an RTS frame transmitted from the STA or a CTS frame transmitted from a frame transmission target STA, may be set not to access the medium during a temporal section indicated by the information included in the RTS/CTS frame. This may be implemented by setting NAV during a time interval.

In the WLAN system illustrated in FIG. 1, the AP 10 may simultaneously transmit data to an STA group including at least one or more STAs among a plurality of STAs 21, 22, 23, 24, and 30 associated with the AP 10. In FIG. 1, it is illustrated that the AP 10 perform MU-MIMO on the STAs 21, 22, 23, 24, 25, and 30, but in a WLAN system supporting a TDLS (Tunneled Direct Link Setup), LS (Direct Link Setup), and a mesh network, an STA that wants to transmit data may transmit a PPDU to a plurality of STAs by using the MU-MIMO transmission technique. Hereinafter, an example of transmitting, by the AP, a PPDU to a plurality of STAs according to the MU-MIMO transmission technique will be described.

Data transmitted to each STA may be transmitted through mutually different spatial streams. A data frame transmitted by the AP 10 may be mentioned as a PPDU generated in the physical layer (PHY) of the WLAN system and transmitted. In an embodiment of the present invention, it is assumed that a transmission target STA group paired with the AP 10 based on MU-MIMO includes STA1(21), STA2(22), STA3(23), and STA4(24). Here, a spatial stream may not be allocated to a particular STA of the transmission target STA group, so data may not be transmitted. Meanwhile, it is assumed that the STAa 30 is coupled with the AP but not included in the transmission target STA group.

One of the greatest characteristics of the next-generation WLAN system is supporting a MU-MIMO transmission technique of transmitting several spatial streams to a plurality of STAs by using multiple antennas. This can enhance throughput of the system overall.

In IEEE 802.11n standard, two or more transmission antennas are allowed to be used, while IEEE 802.11n supports four antennas, and IEEE 802.11ac may support eight antennas. Also, when several transmission antennas are used, data may be transmitted by using transmission beamforming technique in order to improve reception performance of a signal.

The AP, which wants to transmit data in the environment in which a plurality of STAs exist, transmits a PPDU through a beamforming method in order to transmit data from the transmission target STA group. Thus, in order to obtain channel information, the AP and/or an STA, which want to transmit a PPDU by using the MU-MIMO transmission technique, require channel information regarding each of the transmission target STAs, so channel sounding is required to be performed to obtain channel information with respect to each of the transmission target STAs.

Channel sounding for MU-MIMO may be started by a transmitter that wants to transmit a PPDU through beamforming The transmitter may be expressed as a beamformer, and a receiver may be expressed as a beamformee. In the WLAN system supporting DL MU-MIMO, an AP has the status of a transmitter and beamformer, and channel sounding is started by the AP. The STA has a status of a receiver and a beam receiver, and estimate a channel according to the channel sounding started by the AP and report it. A protocol used for the beamformer to obtain channel information of a beam receiver is also called a sounding protocol.

Hereinafter, in describing a channel sounding method in detail, channel sounding in case of transmitting DL MU-MIMO is assumed. However, the channel sounding method described in detail hereinafter may be applied to a wireless communication system supporting general MU-MIMO transmission.

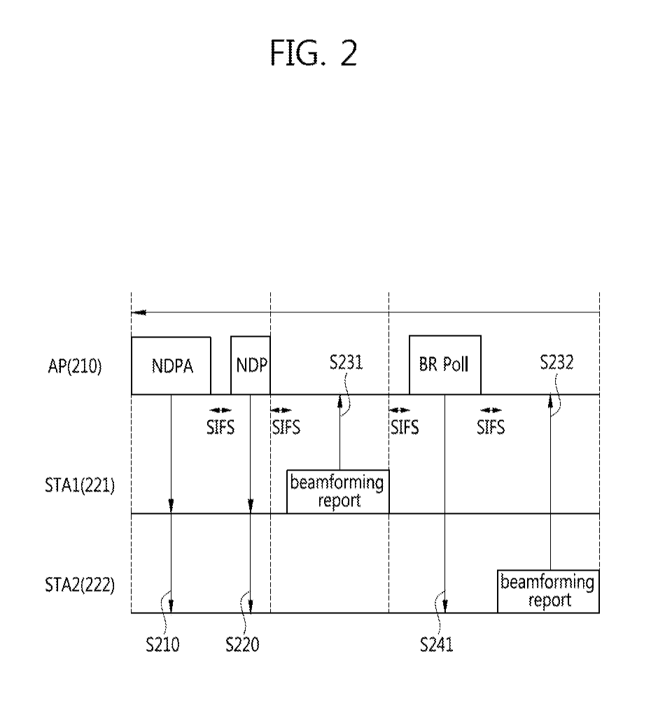

In the next-generation WLAN system, a channel sounding protocol is performed based on an NDP (Null Data Packet) and NDPA (NDP announcement) transmitted by a beamformer to a beam receiver. The NDP has a PPDU format excluding a data field of a MAC layer. A beam receiver uses the NDP in order to extract channel information. Namely, the STA perform channel estimation based on the NDP and feeds back channel state information as an estimation result to the AP. The NDP may be expressed as a sounding frame. NDP-based channel sounding will be described with reference to FIG. 2.

FIG. 2 is a view illustrating a channel sounding method using an NDP in the next-generation WLAN system to which an embodiment of the present invention is applied. In this embodiment, an AP performs channel sounding on two transmission target STAs in order to transmit data to the twp transmission target STAs. However, the AP may perform channel sounding on only one STA.

Referring to FIG. 2, an AP 210 transmits an NDPA frame to an STA1 221 and an STA2 222 (S210). Here, the AP 210 is a beamformer, and the STA1 221 and the STA2 222 are beam receivers. The NDPA frame informs STA1 221 and the STA2 222 that channel sounding will be started and an NDP will be transmitted. Since the NDP does not have MAC layer data, the AP 210 first transmits the NDPA in order to inform about which one of the STA1 221 and the STA2 222 is a beam receiver for receiving the NDP. The NDPA frame may be called a sounding announcement frame. In FIG. 2, the AP 210 indicates that the STA1 221 and the STA2 222 should receive the NDP by using an NDPA frame, and informs the STA1 221 to first respond.

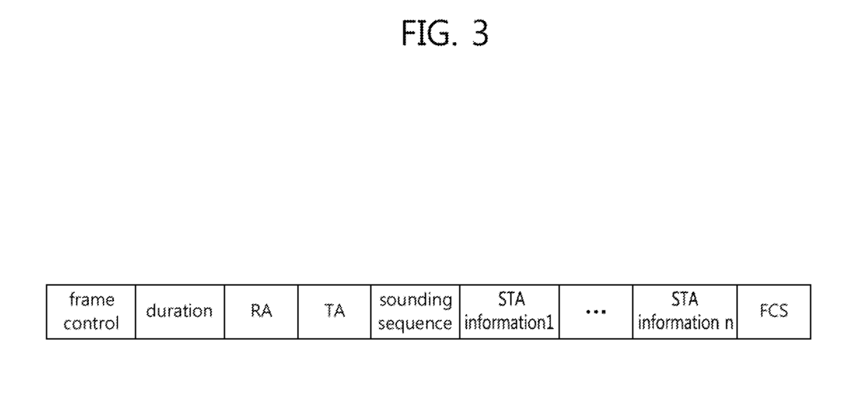

FIG. 3 is a view illustrating the NDPA frame to which an embodiment of the present invention is applied.

Referring to FIG. 3, the NDPA frame includes a frame control field, a duration field, an RA field, a TA field, a sounding sequence field for matching between NPDA and beamforming report frame, one or more STA information (STA info) indicating information regarding which one is a beam receiver for receiving the NDP, and an FCS (frame check sequence) fields. Namely, the NDPA frame includes information for identifying a station for estimating a channel and transmitting a beamforming report (BR) frame including channel state information to the AP. The station (STA) may determine whether to participate in channel sounding through reception of the NDPA frame. Accordingly, the AP 210 includes STA information field including information regarding a sounding target STA in the NDPA frame and transmits the same. The STA information field may be included by one in every sounding target STA. It is to providing information for identifying a station (STA) for transmitting BR frame according to a subsequently transmitted NDP.

Referring back to FIG. 2, when a short interframe space (SIFS) has lapsed after the transmission of the NDPA frame, the AP 210 transmits the NDP to the target station (STA) (S220). The NDP may have a format in which a data field is omitted from the PPDU format. The NDP frame includes a VHT-LTF for each of transmission streams and transmitted to the sounding target STA. Thus, the sounding target stations (STAs) 221 and 222 may estimate a channel based on VHT-LTF of the NDP and obtains channel state information.

After the stations STA1(221) and STA2(222) as beam receivers receive the NDP, the station STA1(221), which is to first respond, transmits a BR frame to the AP 210 (S231). Channel bandwidth information used for transmitting the BR may be narrower than or equal to a channel bandwidth used for transmitting the NDPA frame. The AP 210 may generate a steering matrix required for transmission beamforming by using the channel information included in the BR frame. The BR frame includes a BR field indicating information regarding a channel state and a control information (referred to as ‘MIMO control information’, hereinafter) required for interpreting the channel information indicated by the BR field. The BR field includes compressed beamforming feedback matrix information extracted from the channel state information measured while receiving the NDP.

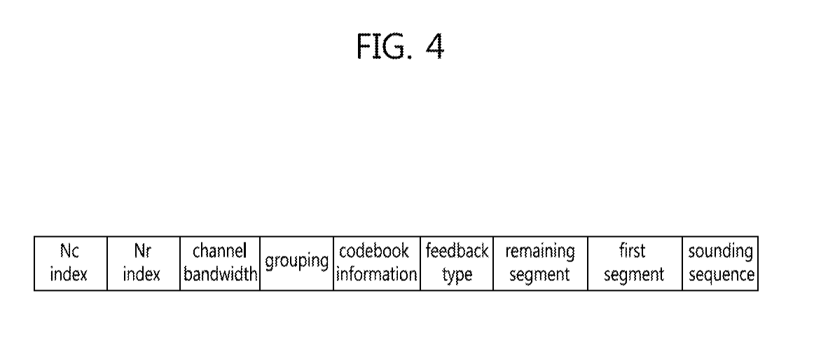

FIG. 4 is a view illustrating MIMO control information to which an embodiment of the present invention is applied.

Referring to FIG. 4, the MIMO control information includes an Nc index field, an Nr index field, a channel bandwidth field, a grouping field, a codebook information field, a feedback type field, a remaining segment field, a first segment field, and a sounding sequence field. When a sequence included in the NDPA transmitted by the AP 210 and a sounding sequence included in the BR frame received by the AP 210 are not identical, the AP 210 does not use the channel information included in the corresponding BR frame.

Referring back to FIG. 2, after the AP 210 receives the BR frame from the STA1(221), the AP transmits a BR poll frame to the STA2(222) (S241). The BR poll frame is used to retransmit a BR frame and sound it to one or more beam receivers. The BR poll frame is transmitted in a unicast manner to the STA2(222).

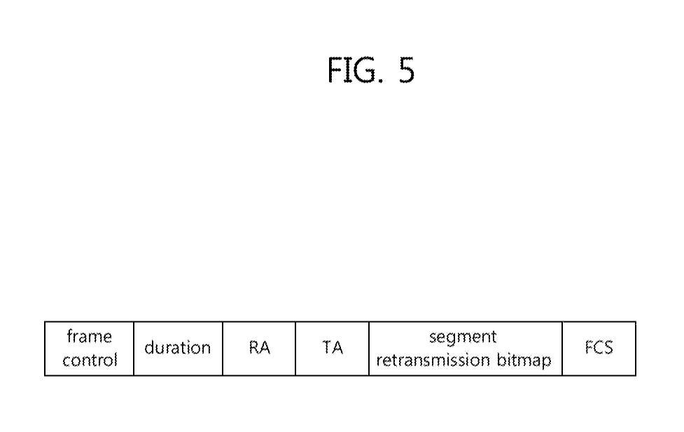

FIG. 5 is a view illustrating a structure of a BR poll frame to which an embodiment of the present invention is applied.

Referring to FIG. 5, the BR frame includes a frame control field, a duration field, an RA field, a TA field, a segment retransmission bitmap field and an FCS (frame check sequence) field.

Referring back to FIG. 2, the STA2(222), which has received the BR poll frame having a reception address of the STA2(222), includes the channel information obtained by using the previously received NDP in the BR frame and transmits the same to the AP 210 (S232). The AP 210 may generate a steering matrix for performing transmission beamforming on each of STA1(221) and STA2(222) or generate a steering matrix for simultaneously performing transmission beamforming (MU-MIMO) on both of STA1(221) and STA2(222), by using the respective channel information obtained from the STA1(221) and STA2(222).

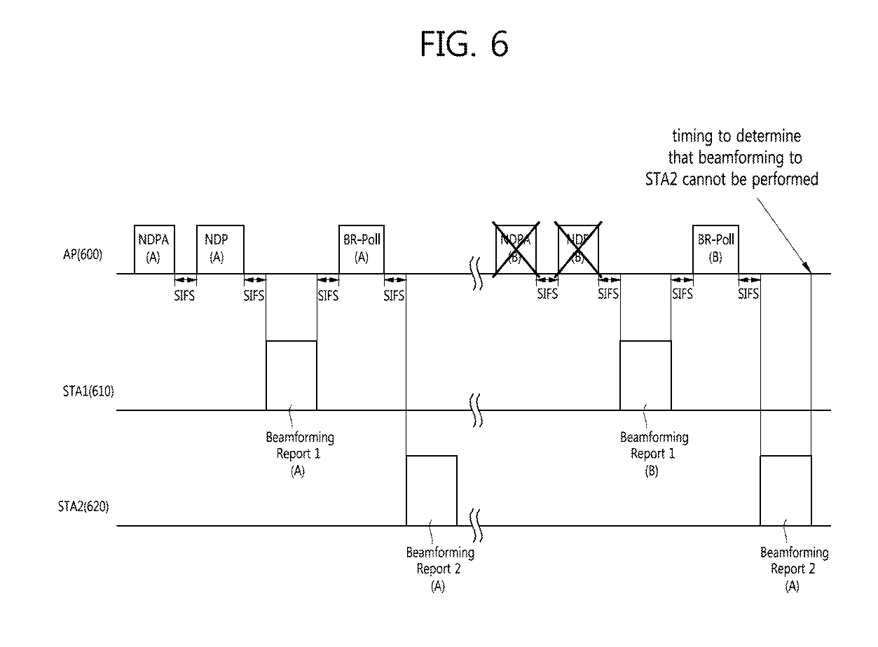

FIG. 6 is a view illustrating an example of a scenario that may be generated during a sounding operation.

Referring to FIG. 6, it is assumed that an AP 600 performs sounding operation with STA1(610) and STA2(620). The STA1(610) and STA2(620) normally receive first NDPA(A) and NDP(A), and STA1(610) transmits BR1 (beamforming report 1) to the AP 600 and STA2(620) transmits a BR2 (beamforming report 2) to the AP 600 in response to the BR poll frame (A).

In this case, it is assumed that the STA2(620) does not receive a second NDPA(B) and NDP(B) and receives only the BR poll frame (B). The BR poll frame (B) does not include current sounding protocol information, so the STA2(620) generates the BR2 frame (A) by using the compressed beamforming feedback matrix the STA2(620) has, and transmits the same. However, the BR2 frame(A) has been transmitted by the compressed beamforming feedback matrix generated based on the NDPA(A) and NDP(A).

The AP 600 compares the sounding sequence of the BR2 frame(A) and the sounding sequence of NDPA(B), and since the two sequences are different, the AP 600 discards the BR2 frame(A) and fails to transmission beamforming on the STA2(620). In addition, the timing at which the AP 600 can determine that transmission beamforming cannot be performed on STA2(620) is a timing after the BR2 frame(A) is received. Here, a size of the BR2 frame(A) may be 10,000 bytes or grater according to a condition, causing a problem in that transmission efficiency is lowered. Thus, a method for effectively preventing erroneous sounding operations is required.

To this end, the present invention proposes a novel structure of a BR poll frame in a sounding protocol for transmission beamforming, whereby transmission of an erroneous BR frame in case that a beam receiver fails to receive the NDPA and the NDP is eliminated and a degradation of transmission efficiency is prevented.

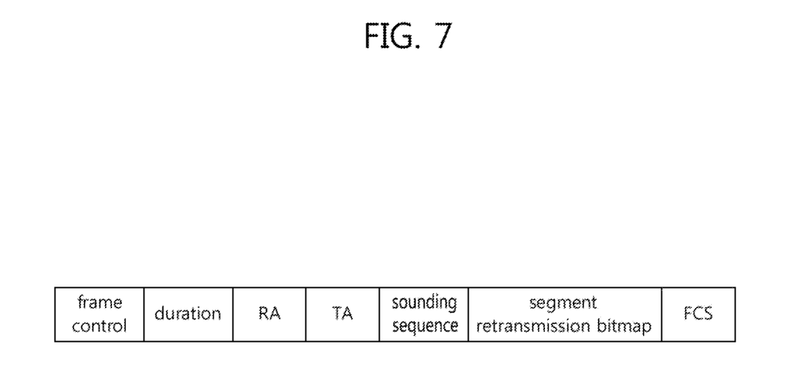

FIG. 7 is a view illustrating a structure of the BR poll frame to which an embodiment of the present invention is applied.

Referring to FIG. 7, a BR poll frame includes a frame control field, a duration field, an RA field, a TA field, a sounding sequence field, a segment retransmission bitmap field, and an FCS (frame check sequence) field. The structure of the BR poll frame illustrated in FIG. 7 is merely an example, and the position of the sounding sequence field may be included or inserted between two fields among the frame control field, the duration field, the RA field, the TA field, the segment retransmission bitmap field, and the FCS field. For example, the position of the sounding sequence field may be behind the segment retransmission bitmap field.

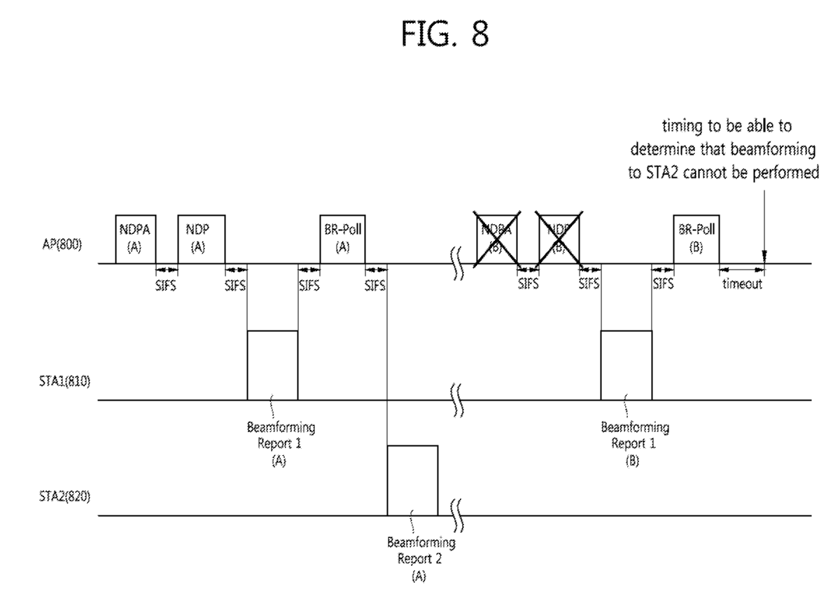

FIG. 8 is a view illustrating a sounding operation based on BR poll frame according to an embodiment of the present invention.

Referring to FIG. 8, it is assumed that, in a second sounding protocol in which an AP 800 transmits NDPA(B) and NDP(B), an STA2(820) does not receive NDPA(B) and NDP(B) and receives the BR poll frame(B). The STA2(820) may check that the compressed beamforming feedback matrix the STA2(820) owns and the sounding sequence of the BR poll frame(B) are different. In this case, the STA2(820) does not transmit the BR frame(B).

Meanwhile, the AP(800) waits for a response with respect to the BR poll frame(B) until when timeout is finished, and when timeout arrives, the AP(800) performs a next operation, rather than waiting for a response any longer. For example, a timeout may be a duration in which the AP(800) waits for a response may be SIFS time+slot time+physical layer reception start delay (PHY Rx Start Delay), which may slightly exceed 25 us.

In this manner, according to the method in which the STA2(620) selectively transmits the BR frame(B) to the AP(800), the AP(800) may determine that it cannot perform beamforming on the STA2(820) immediately when the timeout arrives. Namely, in comparison to the case of FIG. 6, it can be seen that the timing for determination is advanced. Thus, the STA2(820) can prevent unnecessary transmission of a BR frame, and the AP(800) can effectively perform beamforming

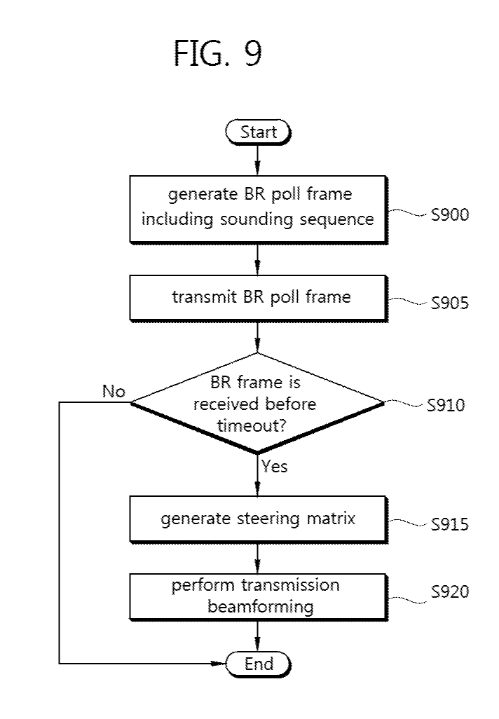

FIG. 9 is a flow chart illustrating a method for performing a sounding operation by an AP according to an embodiment of the present invention.

Referring to FIG. 9, an AP generates a BR poll frame including a sounding sequence according to a current sounding protocol (S900). And, the AP transmits the BR poll frame to a station (STA) (S905).

The AP selectively performs transmission beamforming on the STA according to whether or not a BR frame is received within a timeout. For example, the AP determines whether a BR frame has been received before the timeout (S910). If the BR frame is received from the STA before the timeout, the AP generates a steering matrix by using channel information included in the BR frame (S915), and performs transmission beamforming on the STA based on the steering matrix (S920).

Meanwhile, when the BR frame fails to be received from the STA before the timeout in step S910, the AP does not perform transmission beamforming using the sounding protocol on the station without waiting for a response any longer. Namely, the AP terminates the procedure.

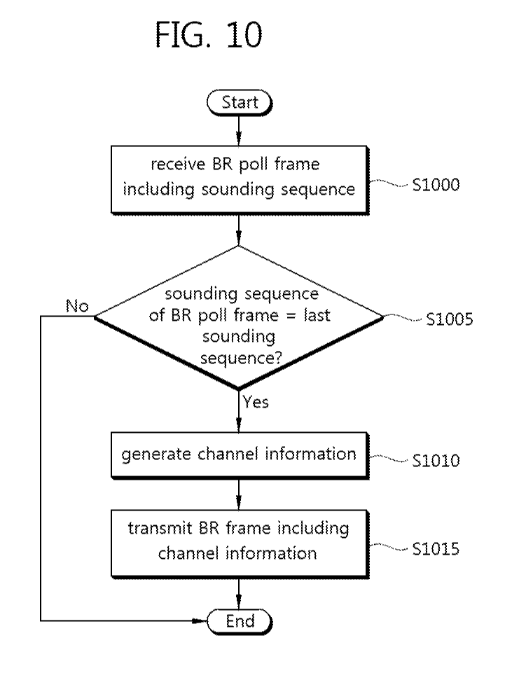

FIG. 10 is a flow chart illustrating a method for performing a sounding operation by an STA according to an embodiment of the present invention.

Referring to FIG. 10, a station (STA) receives a BR poll frame including a sounding sequence from an AP (S1000). The STA compares a sounding sequence of the BR poll frame with the last sounding sequence (S1005). Here, the last sounding sequence refers to a sounding sequence of NDPA or NDP the STA has most recently received from the AP. For example, the last sounding sequence is a sounding sequence included in an NDP the STA has most recently received, which may be a sounding sequence used for obtaining channel information. In another example, the last sounding sequence may be a sounding sequence used as a basis for generating a compressed beamforming feedback matrix of the past.

The STA selectively generates channel information according to whether or not the sounding sequence of the NDPA or NDP and the final sounding sequence are identical, and transmits the BR poll frame to the AP. For example, when the sounding sequence of the BR poll frame and the last sounding sequence are identical, the STA generates channel information (S1010), and transmits the BR frame including the channel information to the AP (S1015). Meanwhile, when the sounding sequence of the BR poll frame and the last sounding sequence are not identical in step S1005, the STA does not perform an operation of generating the channel information or the compressed beamforming feedback matrix and terminates the procedure.

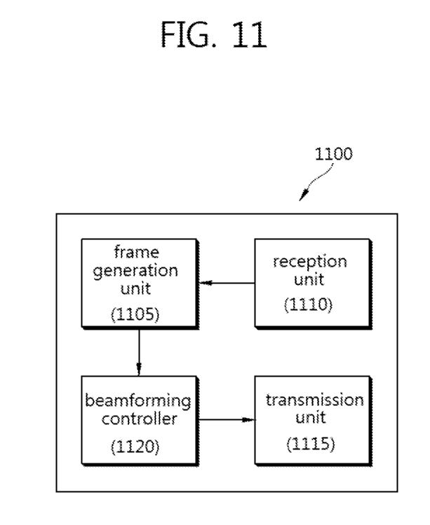

FIG. 11 is a block diagram illustrating an AP performing a sounding operation according to an embodiment of the present invention.

Referring to FIG. 11, an AP 1100 includes a frame generation unit 1105, a reception unit 1110, a transmission unit 1115, and a beamforming controller 1120.

The frame generation unit 1105 generates at least one of an NDPA, NDP, and BR poll frames and transmits the same to the transmission unit 1115. Here, the frame generation unit 1105 may generate a BR poll frame including a sounding sequence as shown in FIG. 7. The transmission unit 1115 transmits an NDPA, NDP, or BR poll frame to an STA.

The reception unit 1110 may receive a BR frame from the STA in response to the NPDA and the NDP, or may receive a BR frame in response to the BR poll frame.

The beamforming controller 1120 selectively performs transmission beamforming on the STA according to whether or not a BR frame has been received within a timeout. For example, the beamforming controller 1120 determines whether or not the reception unit 1110 receives the BR frame from the STA before a timeout since the BR poll frame has been transmitted to the STA. If the reception unit 1110 receives the BR frame from the STA before the timeout, the beamforming controller 1120 generates a steering matrix by using channel information included in the BR frame, and performs transmission beamforming on the STA based on the steering matrix. Meanwhile, if the reception unit 1110 fails to receive the BR frame from the STA before the timeout, the beamforming controller 1120 does not perform transmission beamforming using a sounding protocol on the STA, without waiting for a response any longer.

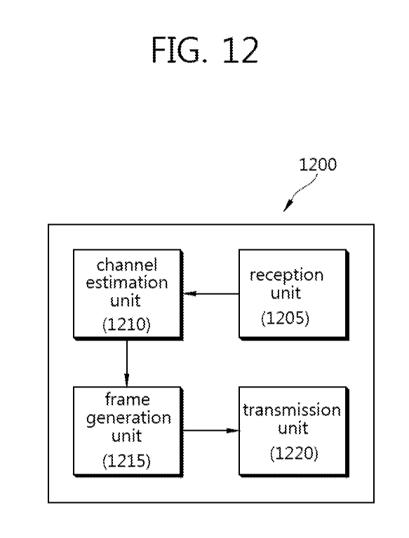

FIG. 12 is a block diagram illustrating an STA performing a sounding operation according to an embodiment of the present invention.

Referring to FIG. 12, an STA 1200 includes a reception unit 1205, a channel estimation unit 1210, a frame generation unit 1215, and a transmission unit 1220.

The reception unit 1205 receives an NDPA, NDP, or BR poll frame from an AP. Here the reception unit 1205 may receive a BR poll frame including sounding sequence field from the AP.

The channel estimation unit 1210 compares the sounding sequence of the BR poll frame with a last sounding sequence. The last sounding sequence is a sounding sequence of an NPDA or an NDP which has been most recently received by the STA 1200 from the AP. For example, the last sounding sequence is a sounding sequence included in an NDP which has been most recently received by the STA 1200, which has been used for the channel estimation unit 1210 to obtain channel information. In another example, the last sounding sequence may be a sounding sequence used as a basis for the channel estimation unit 1210 to generate a compressed beamforming feedback matrix of the past.

The channel estimation unit 1210 may selectively generate channel information or BR frame according to whether or not the sounding sequence of the NDPA or the NDP or the last sounding sequence are identical. For example, when the sounding sequence of the BR poll frame and the last sounding sequence are identical, the channel estimation unit 1210 generates channel information and transmits the channel information to the frame generation unit 1215. The frame generation unit 1215 generates a BR frame including the channel information and transmits the same to the transmission unit 1220. The transmission unit 1220 transmits the BR frame to the AP.

Meanwhile, when the sounding sequence of the BR poll frame and the last sounding sequence are not identical, the channel estimation unit 1210 does not perform the operation of generating channel information or compressed beamforming feedback matrix but terminates the procedure.

All the foregoing functions may be performed by processors such as a microprocessor, a controller, a microcontroller, an ASIC (Application Specific Integrated Circuit) according to software coded to perform the functions or program codes. Designing, development, and implementation of the codes may be obvious to the skilled person in the art based on the description of the present invention.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A method of performing a sounding operation by an access point (AP) in a wireless local area network (WLAN), the method comprising:
generating a beamforming report (BR) poll frame including a sounding sequence;
transmitting the BR poll frame to a station (STA); and
selectively performing transmission beamforming on the station according to whether or not the BR frame is received from the station before a predetermined timeout.

2. The method of claim 1, wherein the selectively performing beamforming comprises:
when the BR frame is received from the station before the timeout, generating a steering matrix by using channel information included in the BR frame; and
performing transmission beamforming on the station based on the steering matrix.

3. The method of claim 1, wherein the selectively performing beamforming comprises:
when the BR frame fails to be received from the station before the timeout, terminating transmission beamforming using a sounding protocol with respect to the station without waiting for a response any longer.

4. The method of claim 1, wherein the timeout may include a short interframe space (SIFS), a slot time, a physical layer reception start delay (PHY Rx Start Delay).

5. An access point (AP) performing a sounding operation in a wireless local area network (WLAN), the AP comprising:
a frame generation unit configured to generate a beamforming report (BR) poll frame including a sounding sequence;
a transmission unit configured to transmit the BR poll frame to a station (STA); and
a beamforming controller configured to selectively perform transmission beamforming on the station according to whether or not the BR frame is received from the station before a predetermined timeout.

6. The access point of claim 5, wherein
when the BR frame is received from the station before the timeout, the beamforming controller generates a steering matrix by using channel information included in the BR frame and performs transmission beamforming on the station based on the steering matrix.

7. The access point of claim 5, wherein
when the BR frame fails to be received from the station before the timeout, the beamforming controller terminates transmission beamforming using a sounding protocol with respect to the station, without waiting for a response any longer.

8. The access point of claim 5, wherein the timeout includes a short interframe space (SIFS), a slot time, a physical layer reception start delay (PHY Rx Start Delay).

9. A method for performing a sounding operation by a station in a wireless local area network (WLAN), the method comprising:
receiving a beamforming report (BR) poll frame from an access point (AP);
comparing a first sounding sequence included in a null data packet (NDP) or an NDP announcement (NDPA) which has been most recently received from the AP with a second sounding sequence included in the BR poll frame; and
selectively transmitting the BR frame including channel information to the AP based on whether or not the first sounding sequence and the second sounding sequence are identical.

10. The method of claim 9, wherein the transmitting of the BR frame to the AP comprises:
when the first sounding sequence and the second sounding sequence are identical, transmitting the BR frame including the channel information to the AP.

11. The method of claim 9, wherein the transmitting of the BR frame to the AP comprises:
when the first sounding sequence and the second sounding sequence are not identical, not performing an operation of generating the channel information or the compressed beamforming feedback matrix by using the second sounding sequence.

12. The method of claim 11, wherein the first sounding sequence is a sounding sequence used as a basis for generating a beamforming feedback matrix of the past.

13. A station performing a sounding operation in a wireless local area network (WLAN), the station comprising:
a reception unit configured to receive a beamforming report (BR) poll frame from an access point (AP);
a channel estimation unit configured to compare a first sounding sequence included in a null data packet (NDP) or an NDP announcement (NDPA) which has been most recently received from the AP with a second sounding sequence included in the BR poll frame; and
a frame generation unit configured to selectively generate a BR frame including channel information based on whether or not the first sounding sequence and the second sounding sequence are identical.

14. The station of claim 13, wherein when the first sounding sequence and the second sounding sequence are identical, the frame generation unit generates the BR frame including the channel information, and
the station further comprising:
a transmission unit configured to transmit the BR frame to the AP.

15. The station of claim 13, wherein when the first sounding sequence and the second sounding sequence are not identical, the frame generation unit does not perform an operation of generating the channel information or a compressed beamforming feedback matrix by using the second sounding sequence.

16. The station of claim 13, wherein the first sounding sequence is a sounding sequence used as a basis for generating a beamforming feedback matrix of the past.
